(19) United States
(12) Patent Application Publication
(10) Pub. No.: US 2012/0052325 A1
(43) Pub. Date: Mar. 1, 2012

(54) METHOD OF ELECTROCHEMICAL MACHINING

(75) Inventors: Alexandr Nickolaevich ZAYTSEV, Ufa (RU); Rinat Miyassarovich SALAKHUTDINOV, Ufa (RU); Timofei Vladimirovich KOSAREV, Ufa (RU); Nickolay Valerievich SERAVKIN, Ufa (RU)

(73) Assignee: PECM INDUSTRIAL, LLC, Ufa (RU)

(21) Appl. No.: 13/097,612

(22) Filed: Apr. 29, 2011

(30) Foreign Application Priority Data
Aug. 27, 2010 (RU) PCT/RU2010/000472

(51) Int. Cl. B32B 3/00; C25F 7/00; C25F 3/02

(52) U.S. Cl. 428/687; 205/686; 205/641; 204/222

(57) ABSTRACT

The invention relates to electrochemical machining of metals and alloys and, more particularly, to high-precision dimensional electrochemical machining. The invention may be used for forming a regular nanometric and micrometric layers on an intricately shaped surface.

Disclosed is a method of electrochemical machining in neutral electrolytes using current pulses which are synchronized with oscillation phases corresponding to the electrolyte pressure maximum in the interelectrode gap, wherein the oscillation mode of the machining electrode and electrode approach speed are set in a specific way for a predetermined frequency and amplitude, characterized in that the electrode approach speed is set in a way that the maximum value Pₘₐₓ (t) of the electrolyte pressure at the interelectrode gap does not exceed an acceptable maximum value Pₘₐₓ of the electrolyte pressure at the interelectrode gap.

The present invention allows increasing precision while maintaining productivity of electrochemical machining using an oscillating machining electrode by means of adjusting the maximum pressure value and ensuring a possibility of supplying current pulses at the moments of optimal combination of the minimum interelectrode gap and maximum electrolyte pressure.

### CROSS-REFERENCE TO RELATED APPLICATION

This application claims the benefits from the International Application PCT/RU2010/000472 filed on Aug. 20, 2010. The content of this application is hereby incorporated by reference in its entirety.

### BACKGROUND OF THE INVENTION

The present invention relates to electrochemical machining (ECM) of metals and alloys and, more particularly, to high-precision dimensional electrochemical machining. The present invention may be used for forming a regular nanometric and micrometric layers on an intricately shaped surface.

The most important advantages of electrochemical machining as compared to mechanical and thermal energy methods include the absence of tool wear, and productivity independence of strength and rigidity of materials to be machined. However, until the present decade electrochemical machining has been rarely used at the finishing workpiece machining stages because it has not been able to provide the required copying precision and quality of the machined surface. For example, technical requirements associated with reducing the machining error to less than 10 μm and the roughness error to less than Ra 0.1 μm could not be met in a number of cases.

An effective solution to the above problems was provided by the use of electrochemical machining techniques providing high discretion degree of the cinematic-geometrical characteristic. In this regard, a method of pulse electrochemical machining using an oscillating machining electrode according to the present invention is considered to be a promising approach.

U.S. Pat. No. 4,213,834, IPC B23H3/02; B23H3/00; B23P1/14, publ. Jul. 22, 1980 discloses a method of electrochemical machining, in which a signal characterizing the shape change of a voltage pulse (when a current source is used) is used to perform the procedure at small interelectrode gap values. In particular, the signal used is proportional to the maximum value of a second voltage derivative at the electrodes during the pulse.

The drawback of this method resides in the fact that when specific workpieces having large uninsulated side surfaces are machined, high currents pass through these surfaces, thus shunting the work current. In this case, the signal characterizing the shape change of a voltage pulse due to processes at the frontal interelectrode gap will be very weak. For example, this takes place at the stage of cutting a three-dimensional machining electrode having a complex cross section into the workpiece, or in the course of piercing openings having small diameters with a tube having uninsulated side surfaces, etc. Another problem relates to unreliable data regarding the gap size due to the fact that characteristic distortions of the voltage pulse shape often occur due to cavitational phenomena or local changes of electrolyte conductivity caused by formation of stagnant zones rather than due to interelectrode gap changes.

SU717847, IPC B23H 3/02, publ. 1977, discloses a method for electrochemical dimensional machining, wherein the machining is carried out using a pulse power supply with a steep current-voltage characteristic while one of the electrodes is oscillated and voltage pulses are applied during the phase when the electrodes are moved towards each other, wherein the present voltage pulse value is controlled by selecting voltage spikes at the sites where the electrodes are moved towards each other and moved apart from each other, respectively, the voltage spike values being adjusted by changing the electrolyte pressure at the entry of an interelectrode gap.

The main drawback of this method resides in the fact that critical case features occurring when the procedure is performed at small interelectrode gap values (less than 0.02 mm) and electrochemical machining is performed for relatively large areas (particularly, more than 15 cm²) are not taken into account. These features are seen as distortions of an oscillograph of voltage pulse, resistance or current. These features of the procedure behavior reflect specific dynamic characteristics and flexibility of the mechanical system of the machine when performing electrochemical machining at low interelectrode gap values, particularly by showing a significant deviation from the sinusoidal curve of electrode oscillations and, therefore, the curve of gap changes at the site of the electrode trajectory adjacent to the phase of its lower position. Said features of the procedure behavior are seen as, for example, distortions of the regular shape of an oscillograph of specific parameters and anticipate a short-circuit failure of the interelectrode gap.

However, the known method does not allow detecting a critical case at the interelectrode gap when performing the procedure at low interelectrode gap values due to absence of a characteristic marker (or signal) informing about the occurrence of a critical case at the interelectrode gap. Absence of such data does not allow providing a stable technological outcome based on main outcome factors and makes it necessary to perform machining at larger interelectrode gaps, which in turn results in decreased procedure characteristics related to productivity, accuracy and quality of machining as well as increased power consumption of the electrochemical machining procedure.

Patent RU 2038928, IPC B23H3/02, published on Jul. 9, 1995 discloses a method for electrochemical dimensional machining using a pulse power supply with a steep current-voltage characteristic. The machining is performed when one of the electrodes is oscillated and voltage pulses are applied during the phase when the electrodes are moved towards each other, wherein the present voltage pulse value is controlled by selecting leading edge voltage spikes at the sites where the electrodes are moved towards each other and trailing edge voltage spikes at the sites where the electrodes are moved apart from each other, the pulse supply moment is adjusted with respect to a moment when the electrodes are moved to a minimum distance towards each other so as to equalize leading edge voltage spikes and trailing edge voltage spikes, pulse supply being delayed when a voltage spike is prevalent at the site where the electrodes are moved towards each other, the pulse voltage being applied in advance when a voltage spike is prevalent at the site where the electrodes are moved apart from each other, the machining electrode feed rate being increased until the third local voltage extremum is formed in the middle of the pulse and maintained so as that to comply with the following relation:

$$0 < \frac{{U}_{π . ∋ .} - {U}_{m i n}}{{U}_{m i n}} ≅ 0 , 2$$

wherein U_{Le} is the voltage amplitude at the third local extremum, Uₘᵢₙ is the minimum voltage value.

The drawback of the above method (as well as of other aforementioned methods) resides in the fact that the condition of an interelectrode medium and/or size of the interelectrode gap is determined based on indirect electrical parameters that substantially depend on a number of hydrodynamic and thermophysical conditions of the interelectrode medium. As a result, the procedure control system performs controlling based on unreliable data, which makes it impossible to perform machining at minimum interelectrode gap values.

USSR inventor's certificate No. 1839372, IPC B23H 7/26, published on Apr. 20, 1996 discloses a device for dimensional electrochemical machining having an oscillating machining electrode. This device comprises an eccentric shaft driven by an electric motor via an angular joint coupling, said shaft being connected via a spring plate to a rammer carrying the machining electrode. The oscillation mode and speed of the machining electrode are determined by a non-uniform rotation of a guided fork of the coupling, thus maintaining the minimum gap, which allows increasing the fabrication current passing time.

The drawback of this device relates to its structural complexity and invariability of the eccentric shaft non-uniform rotation law, which constrains current pulse supply at optimal interelectrode gap values and optimal electrolyte pressure.

The closest prior art method as regards the present invention and claimed technical effect thereof is disclosed in Russian patent application No. 2008132342, IPC B23H7/30, published on Feb. 10, 2010 This patent application relates to the method for electrochemical machining in neutral electrolytes at low interelectrode gap values using current pulses which are synchronized with oscillation phases, said oscillation phases corresponding to the maximum electrolyte pressure at the interelectrode gap, wherein for a predetermined frequency and amplitude the machining electrode oscillation mode and electrode approach speed are selected in such a way that the duration of an elevated pressure pulse is equal to or exceeds the duration of a current pulse, and the maximum pressure amplitude is reached at the minimum interelectrode gap value, the pressure in the interelectrode gap being determined based on a ratio of the supply force value to the working area of the machining electrode, the current pulse supply phase being adjusted with respect to the pressure maximum in such a way that an area defined by the curve of the electrical resistance change at the interelectrode gap is minimal during the current pulse.

The drawback of the above prototype relates to the lack of control over the maximum electrolyte pressure value at the interelectrode gap when the machining electrode converges (oscillates), which results in reduced machining precision and productivity.

The object of the invention is to increase precision while maintaining productivity of electrochemical machining using an oscillating machining electrode by means of adjusting the maximum pressure value and ensuring a possibility of supplying current pulses at the moments of optimal combination of the minimum interelectrode gap and maximum electrolyte pressure.

### BRIEF SUMMARY OF THE INVENTION

According to the first embodiment, the object set above is attained by providing a method of electrochemical machining in neutral electrolytes at small interelectrode gap values using current pulses which are synchronized with oscillation phases corresponding to the electrolyte pressure maximum at the interelectrode gap, the oscillation mode of the machining electrode and electrode approach speed being set in a specific way for a predetermined frequency and amplitude. According to the invention, the electrode approach speed is set in a way that maximum value Pₘₐₓ (t) of the electrolyte pressure at the interelectrode gap does not exceed an acceptable maximum value Pₘₐₓ of the electrolyte pressure at the interelectrode gap in predetermined conditions.

According to the second embodiment, the object set above is attained by providing a method of electrochemical machining in neutral electrolytes at small interelectrode gap values using current pulses which are synchronized with oscillation phases corresponding to the electrolyte pressure maximum at the interelectrode gap, the oscillation mode of the machining electrode and electrode approach speed being set in a specific way for a predetermined frequency and amplitude. According to the invention, when the maximum value Pₘₐₓ (t) of the electrolyte pressure at the interelectrode gap is higher than an acceptable maximum value Pₘₐₓ of the electrolyte pressure at the interelectrode gap, the electrode approach speed is decreased, and when the maximum value Pₘₐₓ (t) of the electrolyte pressure at the interelectrode gap is lower than the acceptable maximum value Pₘₐₓ of the electrolyte pressure at the interelectrode gap, the electrode approach speed is increased, the maximum value Pₘₐₓ (t) of the electrolyte pressure at the interelectrode gap being maintained in a range 0,8 Pₘₐₓ≦Pₘₐₓ (t)≦Pₘₐₓ.

Further, according to the invention, when harmonic sinusoidal oscillations of the machining electrode are used at the maximum value Pₘₐₓ (t) of the electrolyte pressure at the interelectrode gap higher than the acceptable maximum value Pₘₐₓ of the electrolyte pressure in the interelectrode gap, the oscillation frequency of the machining electrode is decreased, and when said oscillations are used at the maximum value Pₘₐₓ(t) of the electrolyte pressure in the interelectrode gap lower than the acceptable maximum value Pₘₐₓ of the electrolyte pressure in the interelectrode gap, the oscillation frequency of the machining electrode is increased.

The invention is further elucidated by accompanying drawings. FIG. 1 shows time dependence diagram of the pressure distribution at the interelectrode gap according to the first embodiment, wherein the electrode approach speed (the machining electrode oscillation) is not controlled. FIG. 2 shows time dependence diagrams of the pressure distribution at the interelectrode gap according to the second embodiment, wherein the electrode approach speed (the machining electrode oscillation) is controlled.

### DETAILED DESCRIPTION OF THE INVENTION

The invention is illustrated for better understanding by way of non-limiting example embodiments thereof, which are discussed in more detail below

An electrolyte (aqueous solution of an oxygen-containing salt) is pumped through an interelectrode gap under pressure Po. A machining electrode performs harmonic oscillations S(t) coaxially to the supply direction. The workpiece and machining electrode are connected to a unipolar pulse power supply with a steep current-voltage characteristic. Tests and calculations show that when the machining electrode and workpiece are moved towards each other in an area before the lower position phase of the machining electrode due to viscous friction of the electrolyte pushed out from the interelectrode gap, the pressure P(t) in the interelectrode gap reaches its maximum value (FIG. 1). For predetermined conditions and electrochemical machining modes, an acceptable maximum pressure value Pₘₐₓ is determined based on predetermined minimum gap Sₘᵢₙ, area to be machined F and rigidity of the technological system J, said value being compared to the current pressure value Pₜ in the interelectrode gap during the machining.

Pₘₐₓ=k₁·J·Sₘᵢₙ/F,

wherein
Pₘₐₓ is the acceptable maximum pressure value, MPa; k₁ is the coefficient defined by the shape and size of the surface to be machined; J is the rigidity of the technological system, N/μm; Sₘᵢₙ is the predetermined minimum gap, mm; F is the area to be machined, mm² (first embodiment).

According to the second embodiment, if P(t)>Pₘₐₓ the electrode approach speed is decreased, and if P(t)<Pₘₐₓ the electrode approach speed is increased, the maximum value Pₘₐₓ (t) of the electrolyte pressure at the interelectrode gap being maintained in a range 0,8 Pₘₐₓ≦Pₘₐₓ (t)≦Pₘₐₓ (FIG. 2).

### EXAMPLE

The electrochemical machining of a workpiece made of high-alloyed chromium steel 40×13 in a 10% aqueous solution of sodium nitrate was carried out using an ET500 machine having axial rigidity J=40 N/μm and a cylindrical machining electrode having 400 mm² area. Before the machining procedure, the oscillating machining electrode and workpiece to be machined were moved to the point of contact without supplying fabrication current pulses, and then were moved apart to a predetermined distance of a minimum interelectrode gap Sₘᵢₙ=0.01 mm. Then the following machining mode was set: electrolyte pressure at the entry of the interelectrode gap Po=0.25 MPa; supply rate 0.15 mm/min; electrolyte temperature 18° C.; current pulse and machining electrode oscillation frequency 67 Hz; current pulse duration 2.5 ms; oscillation amplitude of the machining electrode in the idle run 0,24 mm, voltage pulse amplitude at the moment of the maximum electrolyte pressure at the interelectrode gap 10V. In addition to current and voltage measurements, the supply force and interelectrode gap changes were also measured during the machining. The minimum value of the interelectrode gap was increased by approximately 17% upon completing the transitional procedure. The supply of a fabrication current pulse at the moment Pₘₐₓ (t) was accompanied by a voltage spike Uₘₐₓ at the pulse fronts. As a result, the machining error was increased by approximately 20% as compared to the machining at frequency 47,5 Hz (see the table below, optimal mode meeting the requirement 0,8 Pₘₐₓ≦Pₘₐₓ (t)≦Pₘₐₓ.

TABLE

| f, Hz | Pₘₐₓ MPa | Pₘₐₓ(t), MPa | Sₘᵢₙ (t), mm | Uₘₐₓ, V |
|---|---|---|---|---|
| 67 | 1.1 | 2.4 | 0.023 | 18 |
| 47.5 | 1.1 | 1 | 0.014 | 13 |

Therefore, the machining at the optimal machining electrode oscillation frequency (optimal approach speed of the machining electrode based on the conditions of the electrolyte pressure maximum in the interelectrode gap and minimum changes of a predetermined interelectrode gap) provides higher electromechanical machining precision while maintaining productivity thereof.

Thus, the present invention allows increasing precision while maintaining productivity of electrochemical machining using an oscillating machining electrode by means of adjusting the maximum pressure value and ensuring a possibility of supplying current pulses at the moments of optimal combination of the minimum interelectrode gap and maximum electrolyte pressure.

We claim:

1. A method of electrochemical machining in neutral electrolytes using current pulses which are synchronized with oscillation phases corresponding to the electrolyte pressure maximum in the interelectrode gap, wherein the oscillation mode of the machining electrode and the electrode approach speed are selected depending on the predetermined frequency and amplitude of oscillation, the electrode approach speed being selected to provide the maximum value Pₘₐₓ (t) of the electrolyte pressure at the interelectrode gap not exceeding an acceptable maximum value Pₘₐₓ of the electrolyte pressure at the interelectrode gap.

2. A method of electrochemical machining in neutral electrolytes using current pulses which are synchronized with oscillation phases corresponding to the electrolyte pressure maximum in the interelectrode gap, wherein the oscillation mode of the machining electrode and electrode approach speed are selected depending on a predetermined frequency and amplitude of oscillations, the method further comprising a control step as follows: when the maximum value Pₘₐₓ (t) of the electrolyte pressure at the interelectrode gap is higher than an acceptable maximum value Pₘₐₓ of the electrolyte pressure at the interelectrode gap, the electrode approach speed is decreased, and when the maximum value Pₘₐₓ (t) of the electrolyte pressure at the interelectrode gap is lower than the acceptable maximum value Pₘₐₓ of the electrolyte pressure at the interelectrode gap, the electrode approach speed is increased, the maximum value Pₘₐₓ (t) of the electrolyte pressure at the interelectrode gap being maintained in a range 0,8 Pₘₐₓ≦Pₘₐₓ (t)≦Pₘₐₓ.

3. The method according to claim 2, characterized in that when harmonic sinusoidal oscillations of the machining electrode are used at the maximum value Pₘₐₓ (t) of the electrolyte pressure in the interelectrode gap being higher than the acceptable maximum value Pₘₐₓ of the electrolyte pressure in the interelectrode gap, the oscillation frequency of the machining electrode is decreased, and when said oscillations are used at the maximum value Pₘₐₓ (t) of the electrolyte pressure in the interelectrode gap being lower than the acceptable maximum value Pₘₐₓ of the electrolyte pressure in the interelectrode gap, the oscillation frequency of the machining electrode is increased.

4. An apparatus for electrochemical machining in neutral electrolytes comprising:
a current pulse generator for generating current pulses which are synchronized with oscillation phases corresponding to the electrolyte pressure maximum in the interelectrode gap, and
an oscillating machining electrode, wherein the shape and approach speed of the electrode are selected based on predetermined frequency and amplitude in a way that a maximum value Pₘₐₓ(t) of the electrolyte pressure in the interelectrode gap does not exceed an acceptable maximum value Pₘₐₓ of the electrolyte pressure in the interelectrode gap.

5. An apparatus for electrochemical machining in neutral electrolytes comprising:
a current pulse generator generating current pulses which are synchronized with oscillation phases corresponding to the electrolyte pressure maximum in the interelectrode gap,
an oscillating machining electrode, wherein the shape and approach speed of the electrode are selected based on the predetermined frequency and amplitude, and
a control unit for controlling the process in a way that when the maximum value of the electrolyte pressure in the interelectrode gap Pₘₐₓ(t) is higher than an acceptable maximum value Pₘₐₓ of the electrolyte pressure in the interelectrode gap, the electrode approach speed is decreased, and when the maximum value Pₘₐₓ(t) of the electrolyte pressure in the interelectrode gap is lower than the acceptable maximum value Pₘₐₓ of the electrolyte pressure in the interelectrode gap, the electrode approach speed is decreased, the maximum value Pₘₐₓ(t) of the electrolyte pressure in the interelectrode gap being maintained in a range 0,8 Pₘₐₓ≦Pₘₐₓ (t)≦Pₘₐₓ.

6. An article of manufacture made of a metal or metal alloy, obtained by the method of claim 2, wherein said article has a regular surface layer characterized by roughness less than Ra 0.1 μm.
